(19) United States
(12) Patent Application Publication
(10) Pub. No.: US 2021/0190919 A1
(43) Pub. Date: Jun. 24, 2021

(54) DETECTION SYSTEM USING OPTICAL SCANNING ELEMENT WITH GLASS BODY AND REFLECTIVE MEMBER

(71) Applicant: Veoneer US, Inc., Southfield, MI (US)

(72) Inventor: Bernard de Mersseman, Lowell, MA (US)

(73) Assignee: Veoneer US, Inc., Southfield, MI (US)

(21) Appl. No.: 16/725,165

(22) Filed: Dec. 23, 2019

(51) Int. Cl. G01S 7/481; G01S 17/93

(52) U.S. Cl. CPC G01S 7/4817; G01S 17/93; G01S 7/4814

(57) ABSTRACT

A detection system for a vehicle in an environment includes LiDAR transmitters and receivers configured to operate along an optical path. A reflective mirror is positioned along the optical path and configured to move to redirect light beams to scan the environment in a first direction. An optical scanning element has a glass body in the shape of a rectangular prism and a reflective member within the glass body. The optical scanning element is positioned along the optical path and configured to move around an axis to redirect the light beams to scan the environment in a second direction.

### FIELD OF THE TECHNOLOGY

The subject disclosure relates to object detection and more particularly to detection systems for vehicles.

### BACKGROUND OF THE TECHNOLOGY

Vehicles benefit from having detection systems which seek information on a wide variety of information about the vehicle surroundings. Detection systems can be used for collision avoidance, self-driving, cruise control, and the like. Detection systems often seek information such as bearing, range, velocity, reflectivity, and image data on objects within the surrounding environment. LiDAR is one type of technology typically employed to help obtain information on the surroundings and provide the information to the driver or to a computer system within the vehicle.

In LiDAR systems in particular, it is important to combine very wide field of view with high resolution to ensure accurate information on the surroundings is obtained. This is often accomplished by providing a large number light transmitters and receivers. However, large transmitter/receiver arrays can add significantly to the cost of a detection system. Other LiDAR systems use scanning systems which employ rotating reflective parts to minimize the number of transmitters and receivers required. However, these systems can be bulky and/or can result in poor resolution at different areas within a scan pattern.

### SUMMARY OF THE TECHNOLOGY

In light of the needs described above, in at least one aspect, the subject technology relates to a compact and cost effective vehicle detection system. More particularly, in at least one aspect, the subject technology relates to a LiDAR system which can accurately scan a wide field of view in both azimuth and elevation without requiring a large array of light transmitters and receivers.

In at least one aspect, the subject technology relates to a detection system for a vehicle in an environment. The system includes at least one LiDAR transmitter configured to transmit a light beam along an optical path and into the environment. The system includes a reflective mirror positioned along the optical path and configured to move to redirect the light beam to scan the environment in a first direction. The system includes an optical scanning element, the optical scanning element having a glass body in the shape of a rectangular prism and a reflective member within the glass body. The optical scanning element is positioned along the optical path and is configured to redirect the light beam and move around an axis to scan the environment in a second direction. The system includes at least one LiDAR receiver configured to receive a reflected light beam of a corresponding LiDAR transmitter, the reflected light beam returning from the environment.

In some embodiments, the first direction is an elevation direction and the second direction is an azimuth direction. The reflective member can form a cross section of the glass body. An exterior of the glass body can be formed by four transmissive faces. The transmissive faces can include a first pair of two transmissive faces on a first side of the reflective member and forming a first isosceles right triangular prism with the reflective member such that the reflective member is the hypotenuse. Further, the transmissive faces can include a second pair of two transmissive faces on a second side of the reflective member and forming a second isosceles right triangular prism with the reflective member such that the reflective member is the hypotenuse. Each transmissive face can be at a right angle to two of the transmissive faces. In some embodiments, the at least one LiDAR receiver is configured to receive the reflected light beam along the optical path. In some cases, the reflective mirror is configured to oscillate to redirect the light beam to scan the environment in the elevation direction and the optical scanning element is configured to rotate around the axis to scan the environment in an azimuth direction.

In at least one aspect, the subject technology relates to a detection system for a vehicle in an environment, the system including at least one LiDAR transmitter and receiver, a reflective mirror, and an optical scanning element. The LiDAR transmitter is configured to transmit a light beam along an optical path and into the environment. The reflective mirror redirects the light beam and is positioned along the optical path and configured to oscillate to scan the environment in an elevation direction. The optical scanning element has a glass body in the shape of a rectangular prism and is configured to redirect the light beam. The optical scanning element is positioned along the optical path. The optical scanning element is configured to rotate around an axis to scan the environment in an azimuth direction. The optical scanning element has a reflective member with two opposing reflective surfaces within the glass body, the glass body having four external transmissive faces including two faces on each side of the reflective member. The LiDAR receiver is configured to receive a reflected light beam of the LiDAR transmitter, the reflected light beam returning from the environment.

In some embodiments, the LiDAR receiver is configured to receive the reflected light beam along the optical path. The optical path can be straight in the azimuth direction between the at least one LiDAR transmitter, the reflective mirror, and the optical scanning element. The reflective mirror can be positioned between the at least one LiDAR transmitter and the optical scanning element along the optical path. In some embodiments, the reflective mirror is positioned between the LiDAR transmitter and the optical scanning element along the optical path. The optical path can include a first and second portion. In some cases, the first portion of the optical path between the LiDAR transmitter and the reflective mirror extends in a first direction along an azimuth plane. A second portion of the optical path between the reflective mirror and the optical scanning element can extend in a second direction along the azimuth plane, the second direction being orthogonal to the first direction.

In some embodiments, the optical scanning element is configured to rotate continuously during a scanning cycle. The optical scanning element can be configured to oscillate at a predetermined cycle time. In some embodiments, the reflective mirror is configured to oscillate to scan the environment in the elevation direction at a first frequency and the optical scanning element is configured to rotate to scan the environment in the azimuth direction at a second frequency. The first frequency can be greater than the second frequency. In some cases first frequency is over twenty times greater than the second frequency.

In some embodiments, the transmissive faces of the glass body include first and second pairs of transmissive faces. The first pair of two transmissive faces is on a first side of the reflective member, forming a first isosceles right triangular prism with the reflective member such that the reflective member is the hypotenuse. The second pair of two transmissive faces is on a second side of the reflective member, forming a second isosceles right triangular prism with the reflective member such that the reflective member is the hypotenuse. The first transmissive face can form a right angle with a second transmissive face. The second transmissive face can form a right angle with a third transmissive face. The third transmissive face can form a right angle with a fourth transmissive face. The fourth transmissive face can form a right angle with the first transmissive face. The reflective member can form a cross section of the glass body.

In at least one aspect, the subject technology relates to a detection system for a vehicle in an environment. The system includes a LiDAR transmitter configured to transmit a light beam along an optical path and into the environment. The system includes an optical scanning element having a glass body in the shape of a rectangular prism and a reflective member within the glass body. The optical scanning element is configured to redirect the light beam. The optical scanning element is positioned along the optical path and is configured to move around an axis to scan the environment. A LiDAR receiver is configured to receive a reflected light beam of a corresponding LiDAR transmitter, the reflected light beam returning from the environment.

### BRIEF DESCRIPTION OF THE DRAWINGS

So that those having ordinary skill in the art to which the disclosed system pertains will more readily understand how to make and use the same, reference may be had to the following drawings.

FIG. 1 is an overhead block diagram of a detection system for a vehicle in accordance with the subject technology.

FIG. 2a is a rear perspective view of a detection system for a vehicle in accordance with the subject technology.

FIG. 2b is a zoomed in view of an area of FIG. 2a.

FIGS. 2c-2d are front perspective views of the detection system of FIG. 2a

FIG. 3 is a front perspective view of a detection system for a vehicle in accordance with the subject technology.

FIG. 4a is a front perspective view of an optical scanning element for a detection system in accordance with the subject technology.

FIG. 4b is a bottom perspective view of the optical scanning element of FIG. 4a.

FIGS. 5a-5e are overhead schematic views the detection system of FIG. 3 showing an exemplary scan range in the azimuth direction.

FIGS. 6a-6c are side schematic views of the detection system of FIG. 3 showing an exemplary scan range in the elevation direction.

### DETAILED DESCRIPTION

The subject technology overcomes many of the prior art problems associated with vehicle detection systems. In brief summary, the subject technology provides a detection system utilizing an optical scanning element. The advantages, and other features of the systems and methods disclosed herein, will become more readily apparent to those having ordinary skill in the art from the following detailed description of certain preferred embodiments taken in conjunction with the drawings which set forth representative embodiments of the subject technology. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always be vertically above).

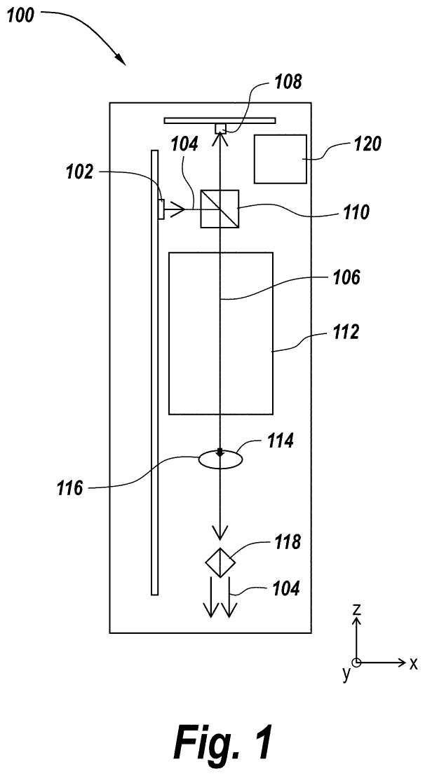

Referring now to FIG. 1, a detection system 100 for a vehicle in accordance with the subject technology is shown. The detection system 100 can be mounted on or within a vehicle (not distinctly shown) and can be used generally to gather information and generate data on the surrounding environment. The detection system 100 employs LiDAR, detecting objects using typical LiDAR components, as are known in the art, in conjunction with other components discussed herein. Thus, while certain components of the detection system 100 are discussed herein which relate to the subject technology, it should be understood that the detection system can include other LiDAR components as are known in the art.

The detection system 100 includes at least one LiDAR transmitter 102 configured to transmit a light beam 104 along an optical path 106. The LiDAR transmitters 102 are emitters of optical radiation such as laser diodes configured to generate pulsed lasers or light beams 104 for reflection off objects within the environment (not distinctly shown, but generally around the detection system and associated vehicle). The light beams 104 transmitted by the LiDAR transmitters 102 can be infrared, and/or near infrared light, for example, to avoid distracting or otherwise effecting the visibility of other drivers. After reflecting off an object within the environment, the light beam returns along the optical path 106 for receipt by at least one LiDAR receiver 108, the LiDAR receiver 108 being an optical detection device. Note that the detection system 100 requires only a single LiDAR transmitter and LiDAR receiver. However, in some cases, multiple LiDAR transmitters and receivers may be included to improve resolution. When multiple LiDAR transmitters and receivers are included, they can be arranged in a column or array to transmit and receive the light beams 104, respectively. A processing module, which can include memory and a processor for carrying out instructions, then processes and stores data related to the range and position of objects within the environment based on the received signals.

The optical path 106 of the light beams is shared by the LiDAR transmitters 102 and LiDAR receivers 108. At the end of the optical path 106, a beam splitter 110 is employed to account for the offset LiDAR transmitters 102 and receivers 108. The beam splitter 110 is a polarized beam splitter which redirects the initially transmitter light beams 104 along the optical path 106, while allowing returning light beams to pass therethrough for receipt by the LiDAR receivers 108. A collimating lens 112 focuses the transmitted light beams 104, which are then directed to a reflective mirror 114. During a scanning cycle, the reflective mirror 114 moves such that the orientation of its reflective surface 116 changes with respect to the elevation direction (i.e. changing the deflection angle along the “y” axis). Therefore, through movement, such as an oscillation of the reflective surface, the reflective mirror 114 redirects the ultimate path of the light beams 104 in the elevation direction. From the reflective mirror 114, the light beams 104 are redirected to an optical scanning element 118. While the properties of the optical scanning element 118 are discussed in greater detail below, the optical scanning element 118 includes a reflective surface within a glass body in the shape of a rectangular prism. During a scanning cycle, the optical scanning element 118 is configured to move around an axis to redirect the light beam 104 for scanning the environment. The optical scanning element 118 can be affixed to rotate around the “y” axis to scan the azimuth direction (i.e. changing field of view along the x-z plane) and can continuously rotate in full, 360 degree, rotations during the scanning cycle, or can oscillate at a predetermined cycle time. Movement of both the reflective mirror 114 and optical scanning element 118 can be accomplished by coupling them to respective actuators, not distinctly shown.

The reflected light beams then return around substantially the same optical path 106, being redirected by the optical scanning element 118 to the reflective mirror 114 before being redirected through the collimating lens 112. The optical path 106 then splits at the beam splitter 110, and the returning light beams pass through the beam splitter 110 and return to the optical receivers 108. Thus, the transmitted light beams 104 and returning light beams share the same optical path 106 through the lens 112, making the LiDAR transmitters 102 and receivers 108 coaxial. In some cases, the positioning of the LiDAR transmitters 102 and receivers 108 can also be reversed, or otherwise positioned to provide a coaxial system. The system 100 can also include a processing module 120, which can be a processor connected to memory and configured to carry out instructions, the processing module 120 being configured to control all aspects of the detection process and to store and process any generated detection data.

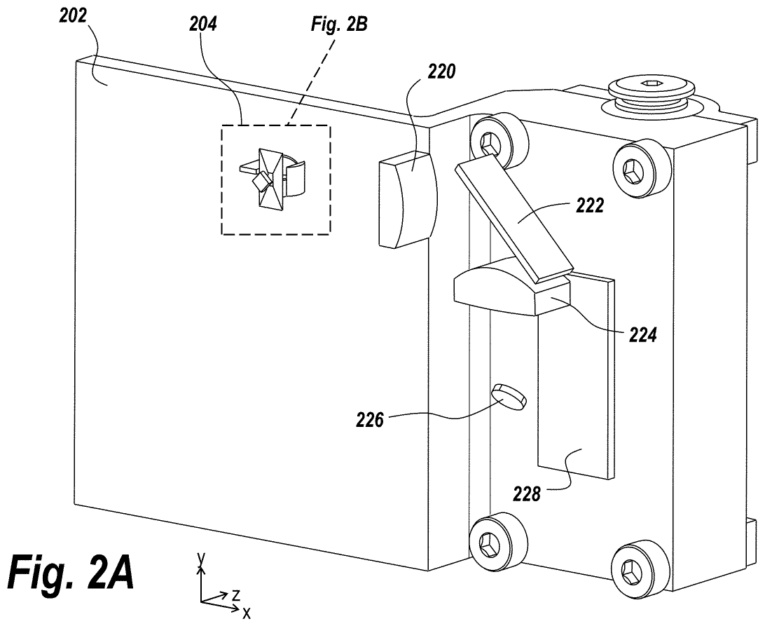

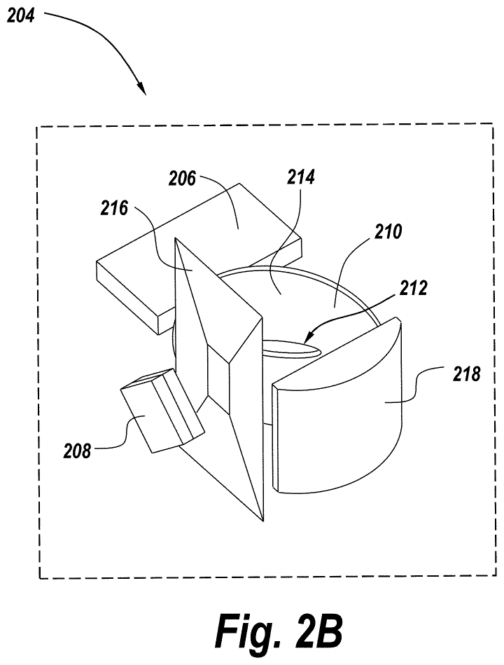

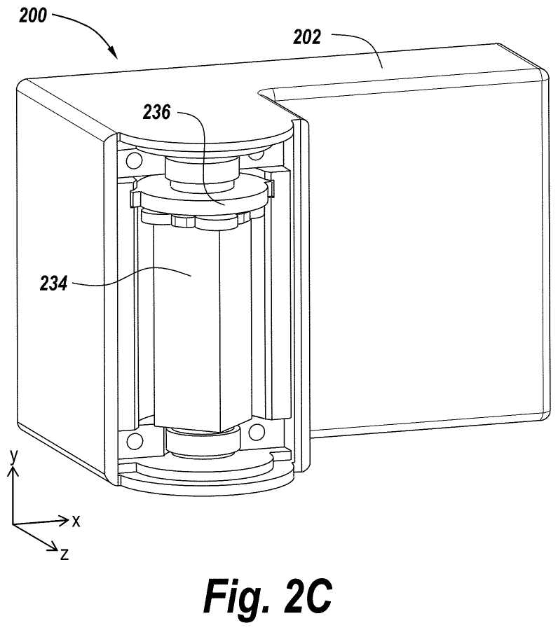

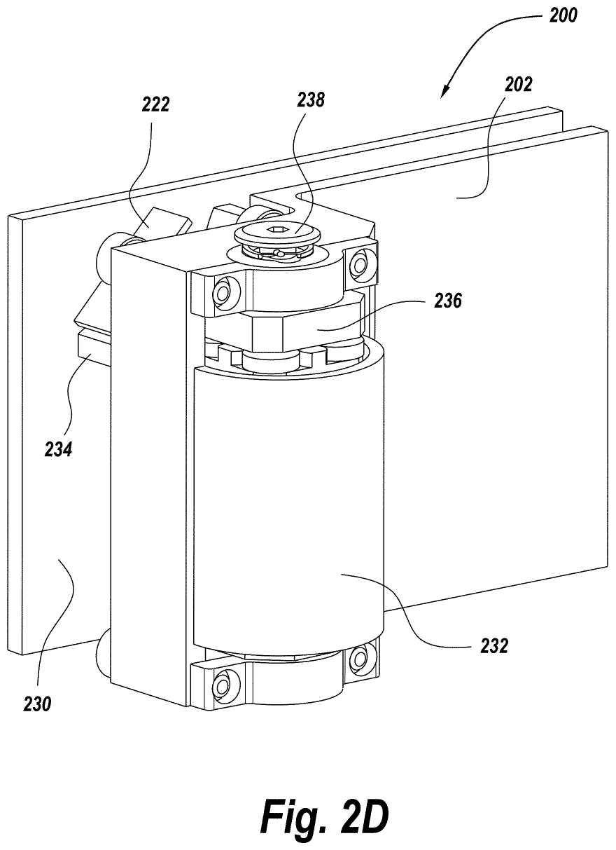

Referring now to FIGS. 2a-2b, rear perspective views of an exemplary arrangement of components of a detection system 200 in accordance with the subject technology are shown. While the arrangement of the detection system 200 is slightly different than that of FIG. 1, it should be understood that the components of the detection system 200 can function similarly to the detection system 100, except as otherwise shown and described herein.

A support structure 202 is shown upon which the other components of the detection system 200 can be affixed. Note, other structural mechanisms attaching the components to the support structure 202 are omitted for ease of reference. The support structure 202 also serves as an outer housing, shielding internal components of the system 200. The system 200 includes components for a co-axial LiDAR system 204, as best seen in FIG. 2b. The LiDAR system 204 includes LiDAR transmitters 206 transmitting light beams through a beam splitter 210 and LiDAR receivers 208 receiving light beams from the beam splitter 210. The beam splitter 210 is a pinhole-type beam splitter, which is generally cheaper than a polarizing beam splitter, such as the beam splitter 110. The beam splitter 210 includes a central aperture 212 through which transmitted light beams can pass similar to a pinhole telescope. Returning light beams reflect off a reflective surface 214 and are sent through a slit 216 before receipt by the LiDAR receivers 208. The slit 216 functions to block out unwanted sunlight, or other interfering light, that may enter the detection system 200, in accordance with similar devices, as are known in the art. Transmitted and returning light beams also pass through a collimating lens 218 that is proximate the other LiDAR system 204 components.

After transmitted light beams pass through the collimating lens 218, the transmitted light beams pass through an additional collimating lens 220, and are redirected, by a folding mirror 222, through an additional collimating lens 224. The transmitted light beams then strike the reflective surface of a scanning mirror 226. The scanning mirror 226 can be a MEMs device which oscillates around an axis to control redirection of the transmitted light beams in the elevation direction (i.e. along the y-axis). The transmitted light beams pass through an additional collimating lens 228 towards an optical scanning element 234 (shown in FIG. 2c). Returning light beams follow the same optical path as the transmitted beams in returning to the LiDAR system 204 for receipt by the LiDAR receivers 208. Notably, various components, such as the collimating lenses 218, 220, 222, 228 and folding mirror 222 are included only to show one exemplary arrangement of components a detection system in accordance with the subject technology. It should be understood that more of fewer of these components, or other standard optical components within a detection and/or LiDAR system, can be used, or said components may be arranged in a different orientation and arrangement. The exemplary components shown herein are not absolutely necessary to implement the subject technology.

Referring now to FIGS. 2c-2d, the system 200 is shown from a front perspective. FIG. 2d is similar to FIG. 2c except that a printed circuit board 230 and glass housing 232 are shown. The printed circuited board 230 is located behind the support structure 202 and can include circuitry or the like for carrying out the control and processing functions of the detection system. The protective glass housing 230 surrounds the optical scanning element 234 and collimating lens 228, connecting to the support structure 202 to form a secure housing.

After passing through the collimating lens 228, the transmitted light beams pass through and/or reflect off the optical scanning element 234. The optical scanning element 234 is connected to an actuator 236 configured to rotate the optical scanning element. The actuator 236 can be, for example, a brushless stator coupled to the support structure 202. The optical scanning element 234 can then be connected to the support structure 202 via coupling to a bearing or bushing 238.

In the arrangement of the system 200, the optical path between the LiDAR transmitter 206 and the reflective mirror 226 would be in one direction with respect to the azimuth plane (i.e. the x-z plane), while the optical path between the reflective mirror 226 and optical scanning element 234 is at substantially a right angle to the optical path between the LiDAR transmitter 206 and the reflective mirror 226, with respect to the azimuth plane. Thus, in this embodiment, the LiDAR transmitter 206 and optical scanning element 234 are offset along the azimuth plane.

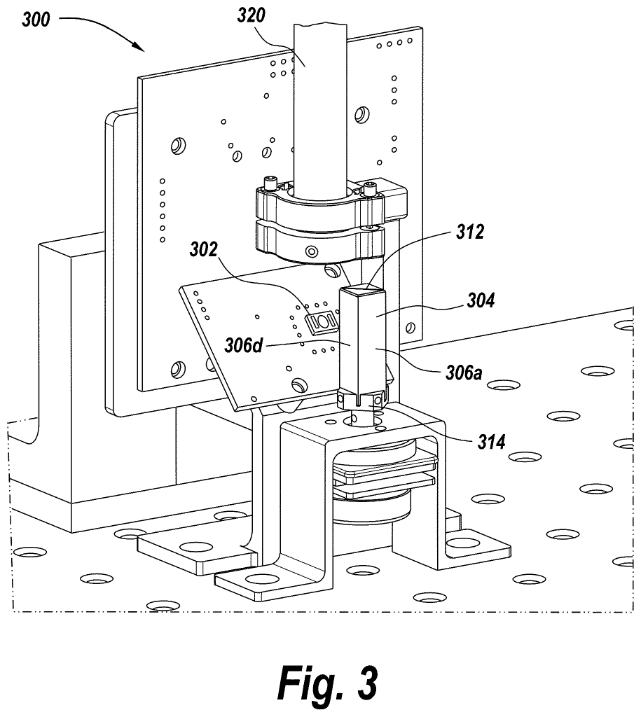

Referring now to FIG. 3, a front perspective view of components of a detection system 300 in accordance with the subject technology is shown. It should be understood that the components of the detection system 300 can function similarly to those of the other detection systems herein, except as otherwise shown and described herein. The specific components of the LiDAR system within the detection system 300 are omitted from FIG. 3. The optical path between the LiDAR system and the reflective mirror 302 can run through collimating lens 320, with the LiDAR system, reflective mirror 302, and optical scanning element 304 positioned in alignment with respect to the azimuth plane (although not necessarily at a shared elevation), providing a compact system while still allowing for a significant scanning range in the azimuth and elevation directions. As with other detection systems shown and described herein, after reflecting off the reflective mirror 302, which can oscillate to change the field of view of the system in the elevation direction, the light beams interact with the optical scanning element 304 before entering the surrounding environment.

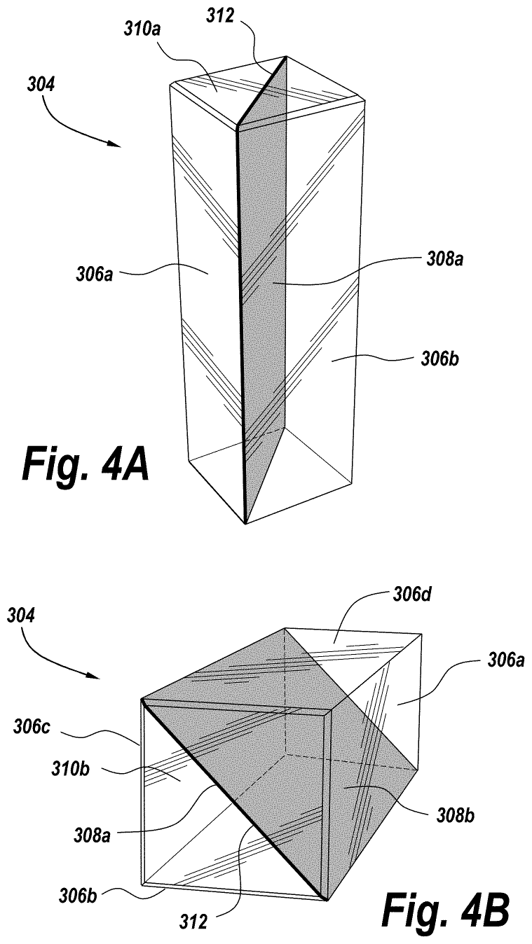

Referring now to FIGS. 4a-4b, the details of the optical scanning element 304 are shown and described in further detail. The optical scanning element 304 has a glass body in the shape of a rectangular prism with an exterior defined by four outer glass faces 306a, 306b, 306c, 306d (generally 306) forming the prism sides which extend between the glass faces 310a, 310b (generally 310) which form the prism ends. In general, the faces 306 sit at right angles to one another. The outer faces 306 are generally transmissive, allowing light to pass therethrough, and allowing light to pass through the glass body of the optical element 304, while redirecting the light as discussed in more detail below. A flat rectangular reflective member 312 with opposing reflective surfaces 308a, 308b forms a diagonal cross section of the optical element 304. The reflective member 312 extends the length of the optical scanning element 304 between the ends 310, running parallel to the outer faces 306. In particular, two of the transmissive faces 306b, 306c are on a first side 308a of the reflective member 312, light passing through those transmissive faces 306b, 306c interacting with the first side 308a. In effect, the sides 306b, 306c form an isosceles right triangular prism with the first side 308a of the reflective member 312 and with the reflective member 312 being the hypotenuse. Similarly other two transmissive faces 306a, 306d are on a second side 308b of the reflective member 312, allowing light passing through to interact with the second side 308b of the reflective member 312. The transmissive faces 306a, 306d likewise form an isosceles right triangular prism with the second side 308b of the reflective member 312 and with the reflective member 312 being the hypotenuse.

Referring again to FIG. 3, an actuator 314 is affixed to the optical scanning element 304 to cause it to oscillate or rotate around the vertical axis, changing the glass face 306 and reflective surface 308 interfacing with the transmitted light beams to change the field of view of the detection system 300 in the azimuth direction. As the transmitted and returning light passes through the moving optical scanning element 304, the glass body of the optical scanning element 304 redirects light and the reflective member 312 completely reflects light which contacts its surface.

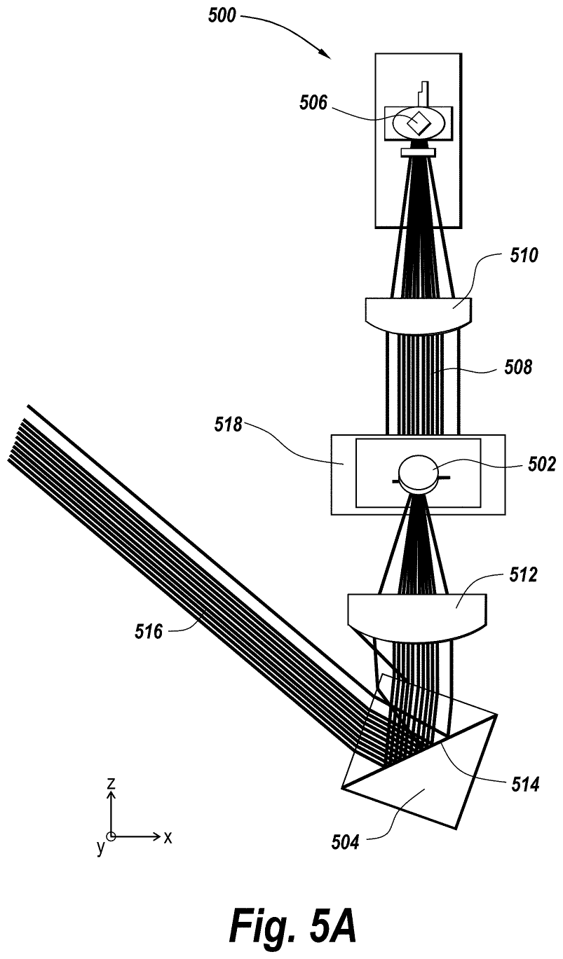

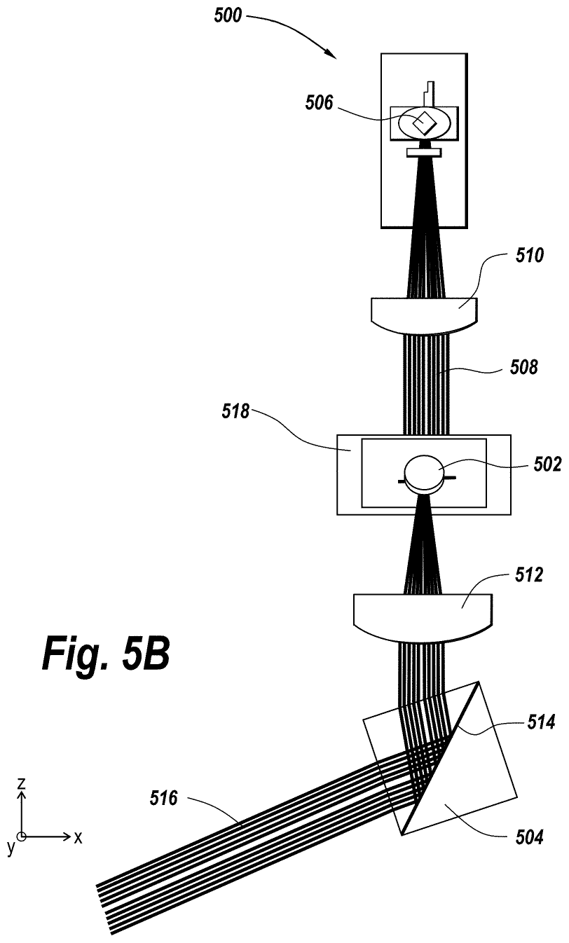

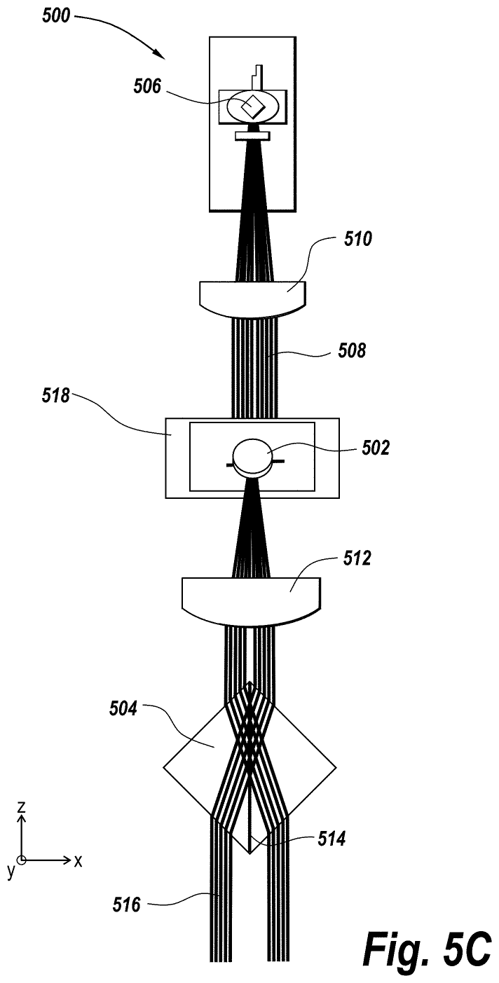

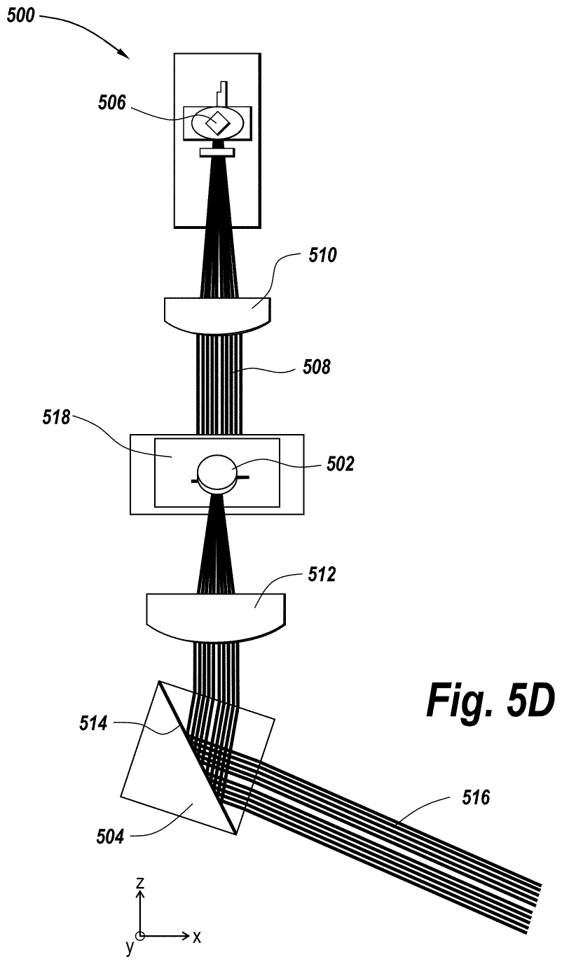

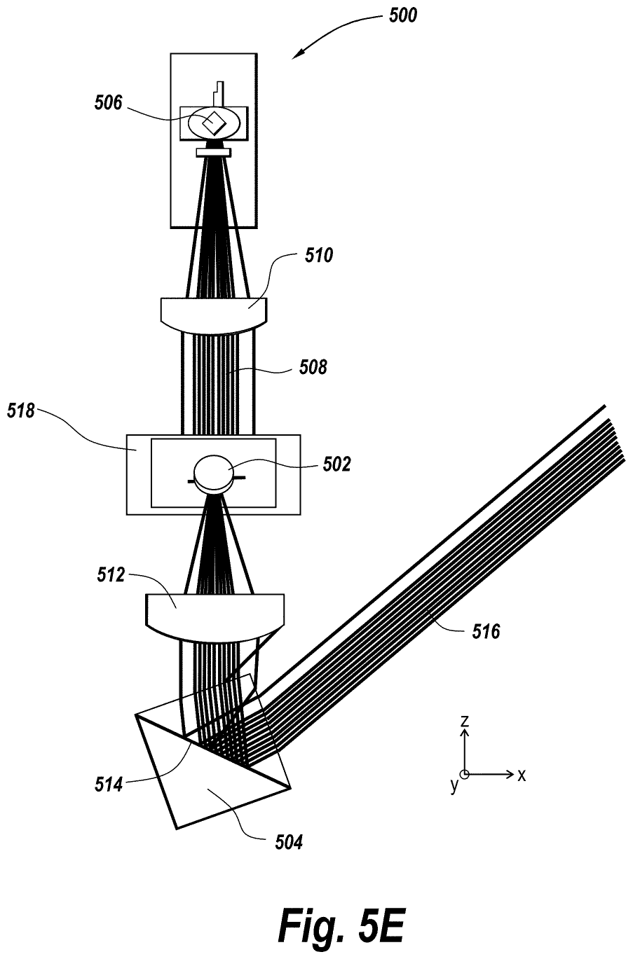

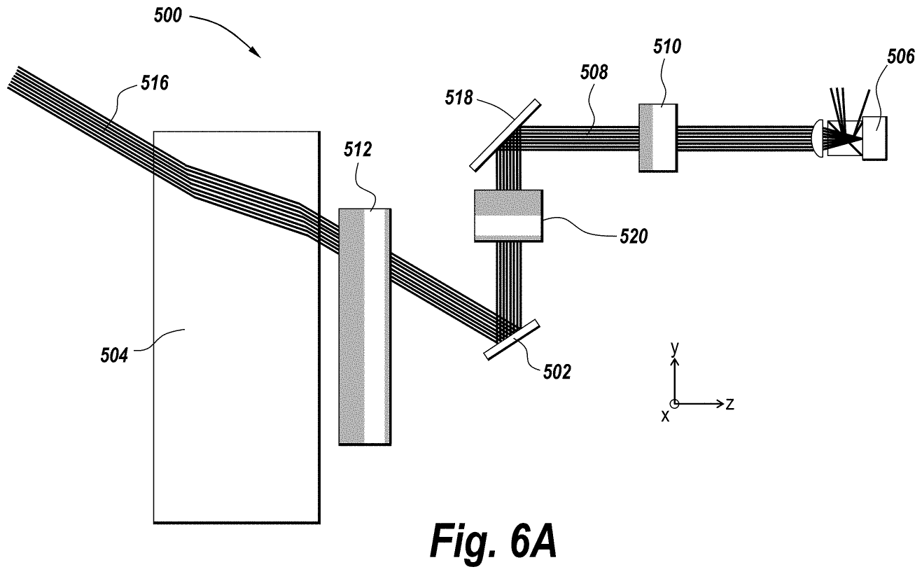

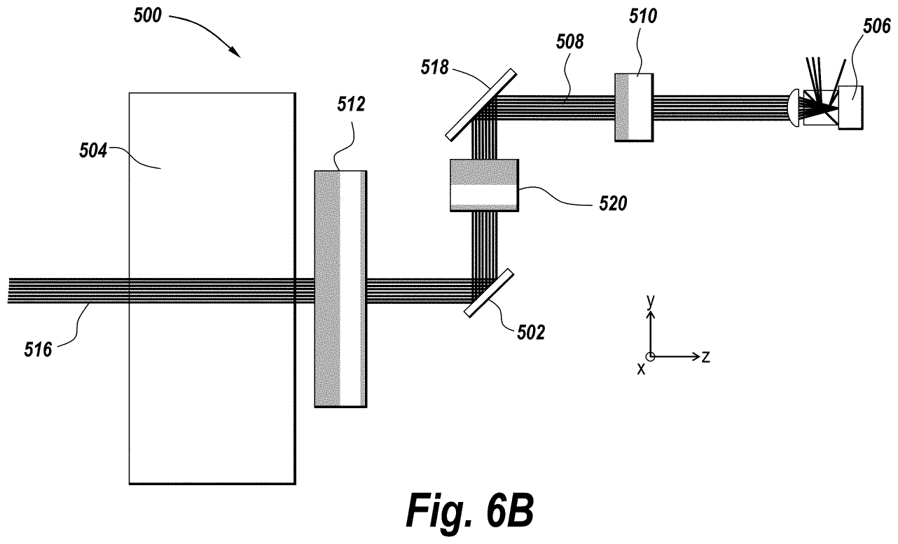

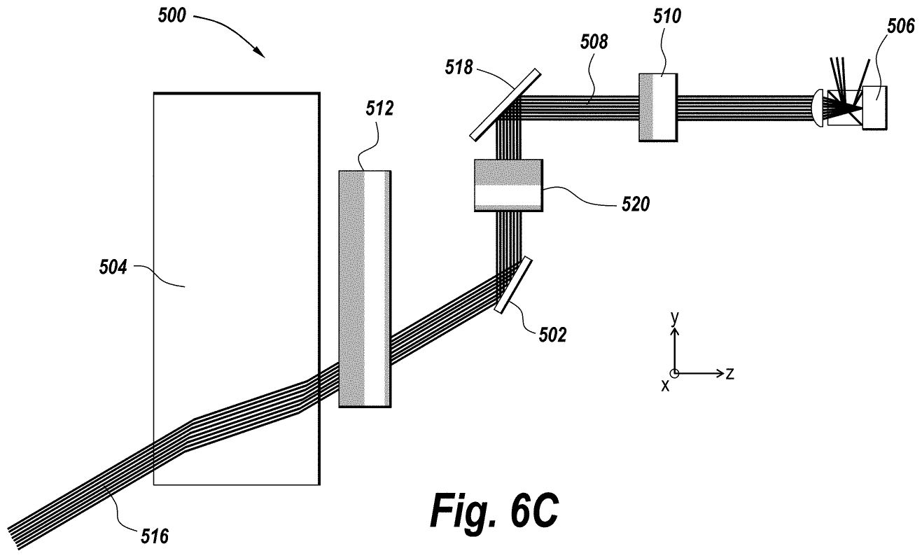

Referring now to FIGS. 5a-6c, schematic diagrams of an exemplary detection system 500 are shown, which can include components at a similar positioning and alignment of the detection system 300. FIGS. 5a-5e show a scanning pattern of the system 500 over an azimuth sweep, while FIGS. 6a-6c show a scanning pattern over an elevation sweep. It should be understood that the detection system 500 can include other components of the detection systems as shown in described herein and the components shown in the detection system 500 are exemplary only, to illustrate a typical scan pattern in accordance with the subject technology.

FIGS. 5a-5e are an overhead view of the scanning pattern of the detection system 500, showing the full range of a scanning pattern in the azimuth direction. In the arrangement shown, the reflective mirror 502, optical scanning element 504, and the LiDAR system 506 (including LiDAR transmitters and receivers, as well as other necessary LiDAR components) are arranged in substantially a straight line in the azimuth plane (understanding there might be a slight offset of some LiDAR system 506 components, for example, as shown when the beam splitter 110 of FIG. 1 is used). In particular, the optical path 508 forms a straight line between the LiDAR transmitters of the LiDAR system 506, the reflective mirror 502, and the optical scanning element 504. A first collimating lens 510 is included between the LiDAR system 506 and the reflective mirror 502 and a second collimating lens 512 is included between the reflective mirror 502 and the optical scanning element 504. A third collimating lens 520 is also located between the reflective mirror 502 and a folding mirror 518, as seen in FIGS. 6a-6c. The configuration of the system 500, with an optical path 508 straight along the azimuth plane between the LiDAR system 506, reflective mirror 502, and optical scanning element 504 (i.e. with the LiDAR transmitters straight behind the optical scanning element 504 in the x-z plane) allows for a large, 270 degree field of view in the azimuth direction.

For explanatory purposes, it is described that the reflective member 514 of the optical scanning element 504 is at 0 degrees of rotation as shown in FIG. 5c, that representing a scan at the boresight of the field of view in azimuth. Therefore, FIG. 5a shows the limits of the field of view in azimuth in one direction, where the reflective member 514 is at an angle of −65 degrees. This allows for the field of view to reach −135 degrees with respect to the boresight as the transmitted and returning light beams 516 reflect off the angled surface of the reflective member 514. Note that while a greater field of view is achievable by the components of the system 500, the components themselves may start to block the field of view of the system 500 at larger angles. FIG. 5b shows the reflective member at an angle of −35 degrees, with the transmitted and returning light beams 516 continuing to reflect off a surface of the reflective member 514. At the position shown in FIG. 5c, the system 500 is scanning directly ahead. The optical element 504 has rotated such that the flat reflective faces of the reflective member 514 are parallel to the direction of the transmitted and returning light beams 516. In this position, the glass body of the optical scanning element 504 helps redirect light around the reflective member 514 so that it does not interfere with the transmission and receipt of light beams 516.

FIG. 5d shows the scanning pattern as the optical scanning element 504 turns in the other direction (i.e. shown at the opposite angle of FIG. 5b). In FIG. 5d, the reflective member 514 is at an angle of 35 degrees and the transmitted and returning light beams 516 scan the other side of the vehicle, as compared to FIG. 5b. Likewise, FIG. 5e shows the opposite scan angle of FIG. 5a, with the reflective member 514 at a 65 degree angle, allowing the detection system 500 to scan at 135 degrees in the azimuth direction. As such, a 270 degree scan in the azimuth direction occurs between as the optical scanning element 504 rotates between the positions shown in FIGS. 5a and 5e.

Referring now to FIGS. 6a-6c, while the azimuth scan occurs, as shown in FIGS. 5a-5e, an elevation scan also occurs. The azimuth scan is controlled by rotation of the optical scanning element 504, while the elevation scan is controlled by oscillation of the reflective mirror 502, although it should be understood that these roles could be reversed in other embodiments. Although the positions of the LiDAR system 506, reflective mirror 502, and optical scanning element 504 are aligned in the azimuth plane, the LiDAR system 506 is at a different elevation (i.e. different position along the y axis) from the reflective mirror 502 and the optical scanning element 504 which are centered at the same elevation. The folding mirror 518 makes this positioning possible, as it is placed directly above the scanning mirror 502 to redirect transmitted light beams 516 from the LiDAR system 506 through the lens 520 and to the scanning mirror 502. Thus, the LiDAR system 506 can be placed directly behind the scanning mirror 502 in the azimuth direction and the light beams still reflect off the scanning mirror 502 to the optical scanning element 504.

For explanatory purposes, FIG. 6b will be described as having a reflective mirror 502 at an angle of 0 degrees, representing a scan angle at the same elevation as the boresight of the detection system 500. FIG. 6a depicts a scan position where the reflective mirror has oscillated to an angle of −15 degrees to obtain a maximum scan angle upwards in the elevation direction, while FIG. 6c depicts a scan position where the reflective mirror 502 has oscillated to an angle of 15 degrees to obtain a maximum scan angle downwards in the elevation direction. While a greater scan range in the elevation direction is possible, the exemplary range of the system 500 has been shown to be effective for capturing the desirable information for a vehicle detection system at a high resolution. Therefore, FIGS. 6a-6c present an exemplary effective elevation scan range which can be achieved by oscillating the reflective mirror 502 between angles of −15 and 15 degrees.

The elevation scan is carried out simultaneously to the azimuth scan, and both scans can have different frequencies. More particularly, the optical scanning element 504 can be configured to have a particular scanning frequency, or to have a particular scanning frequency as compared to the scanning frequency of the reflective mirror 502 to optimize resolution of the detection system 500. Typically, the elevation scan will be at a much quicker frequency than the azimuth scan. In some cases, the scan frequency of the reflective mirror 502 in the elevation direction can be over twenty times greater than the scan frequency of the optical scanning element 504 in the azimuth direction. In other cases, the optical scanning element 504 can rotate at 300 rotations per minute (two azimuth sweeps per rotation), producing a cycle frequency of 10 Hz and the reflective mirror 502 can oscillate at 454 microseconds per cycle period, producing a cycle frequency of 2.2 kHz. The LiDAR transmitters can operate at a pulse repetition frequency of 216 kHz in order to achieve an angular resolution better than 1 degree in both azimuth and elevation. It should be understood that these possibilities are exemplary only, and while the aforementioned examples have been found to be advantageous and provide good resolution, other configurations could also be used. Further, increasing elevation resolution is also possible by increasing the rotation speed of the optical scanning element 504 and accumulating data over successive azimuth scan cycles.

The detection systems shown and described herein are able to achieve a wide field of view and high resolution scanning in both the azimuth and elevation direction. This is achieved while using a low cost system that can scan with as few as a single LiDAR transmitter and receiver, the wide field of view being achieved through the implementation of a moving reflective mirror, moving optical scanning element, and other components as needed. Further, the components of the detection systems can be provided in a compact arrangement, minimizing the space occupied by the detection systems, since so few LiDAR transmitters and receivers are required. As such, the detection systems of the subject technology can provide a high level of detail about the surrounding environment to a vehicle operator, or to automated driving functions within the vehicle or the like, while keeping costs down.

It will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements (e.g. processors, circuitry, and the like) shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A detection system for a vehicle in an environment, comprising:
at least one LiDAR transmitter configured to transmit a light beam along an optical path and into the environment;
a reflective mirror positioned along the optical path and configured to redirect the light beam and to move to scan the environment in a first direction;
an optical scanning element, the optical scanning element having a glass body in the shape of a rectangular prism and a reflective member within the glass body, the optical scanning element positioned along the optical path, the optical scanning element configured to redirect the light beam, the optical scanning element configured to move around an axis to scan the environment in a second direction; and
at least one LiDAR receiver configured to receive a reflected light beam of a corresponding LiDAR transmitter, the reflected light beam returning from the environment.

2. The detection system of claim 1, wherein the first direction is an elevation direction and the second direction is an azimuth direction.

3. The detection system of claim 1, wherein the reflective member forms a cross section of the glass body.

4. The detection system of claim 3, wherein an exterior of the glass body is formed by four transmissive faces.

5. The detection system of claim 4, wherein the four transmissive faces include:
a first pair of two transmissive faces on a first side of the reflective member and forming a first isosceles right triangular prism with the reflective member such that the reflective member is the hypotenuse; and
a second pair of two transmissive faces on a second side of the reflective member and forming a second isosceles right triangular prism with the reflective member such that the reflective member is the hypotenuse.

6. The detection system of claim 3, wherein each transmissive face is at a right angle to two of the transmissive faces.

7. The detection system of claim 1, wherein the at least one LiDAR receiver is configured to receive the reflected light beam along the optical path.

8. The detection system of claim 2, wherein the reflective mirror is configured to oscillate to redirect the light beam to scan the environment in the elevation direction and the optical scanning element is configured to rotate around the axis to scan the environment in an azimuth direction.

9. A detection system for a vehicle in an environment, comprising:
at least one LiDAR transmitter configured to transmit a light beam along an optical path and into the environment;
a reflective mirror positioned along the optical path and configured to redirect the light beam, the reflective mirror configured to oscillate to scan the environment in an elevation direction;
an optical scanning element, the optical scanning element having a glass body in the shape of a rectangular prism, the optical scanning element being positioned along the optical path, the optical scanning element configured to redirect the light beam, the optical scanning element configured to rotate around an axis to scan the environment in an azimuth direction, the optical scanning element having a reflective member with two opposing reflective surfaces within the glass body, the glass body having four external transmissive faces including two faces on each side of the reflective member; and
at least one LiDAR receiver configured to receive a reflected light beam of the at least one LiDAR transmitter, the reflected light beam returning from the environment.

10. The detection system of claim 9, wherein the at least one LiDAR receiver is configured to receive the reflected light beam along the optical path.

11. The detection system of claim 9, wherein:
the optical path is straight in the azimuth direction between the at least one LiDAR transmitter, the reflective mirror, and the optical scanning element; and
the reflective mirror is positioned between the at least one LiDAR transmitter and the optical scanning element along the optical path.

12. The detection system of claim 9, wherein:
the reflective mirror is positioned between the at least one LiDAR transmitter and the optical scanning element along the optical path;
a first portion of the optical path between the at least one LiDAR transmitter and the reflective mirror extends in a first direction along an azimuth plane; and
a second portion of the optical path between the reflective mirror and the optical scanning element extends in a second direction along the azimuth plane, the second direction being orthogonal to the first direction.

13. The detection system of claim 9, wherein the optical scanning element is configured to rotate continuously during a scanning cycle.

14. The detection system of claim 9, wherein the optical scanning element is configured to oscillate at a predetermined cycle time.

15. The detection system of claim 9, wherein:
the reflective mirror is configured to oscillate to scan the environment in the elevation direction at a first frequency; and
the optical scanning element is configured to rotate to scan the environment in the azimuth direction at a second frequency,
wherein the first frequency is greater than the second frequency.

16. The detection system of claim 15, wherein the first frequency is over twenty times greater than the second frequency.

17. The detection system of claim 9, wherein the transmissive faces of the glass body include:
a first pair of two transmissive faces on a first side of the reflective member and forming a first isosceles right triangular prism with the reflective member such that the reflective member is the hypotenuse; and
a second pair of two transmissive faces on a second side of the reflective member and forming a second isosceles right triangular prism with the reflective member such that the reflective member is the hypotenuse.

18. The detection system of claim 9, wherein:
a first transmissive face of the transmissive faces forms a right angle with a second transmissive face of the transmissive faces;
the second transmissive face forms a right angle with a third transmissive face of the transmissive faces;
the third transmissive face forms a right angle with a fourth transmissive face of the transmissive faces; and
the fourth transmissive face forms a right angle with the first transmissive face.

19. The detection system of claim 1, wherein the reflective member forms a cross section of the glass body.

20. A detection system for a vehicle in an environment, comprising:
at least one LiDAR transmitter configured to transmit a light beam along an optical path and into the environment;
an optical scanning element, the optical scanning element having a glass body in the shape of a rectangular prism and a reflective member within the glass body, the optical scanning element positioned along the optical path, the optical scanning element configured to redirect the light beam, the optical scanning element configured to move around an axis to scan the environment; and
at least one LiDAR receiver configured to receive a reflected light beam of the at least one LiDAR transmitter, the reflected light beam returning from the environment.
